(19) United States
(12) Patent Application Publication
(10) Pub. No.: US 2022/0003105 A1
(43) Pub. Date: Jan. 6, 2022

(54) WELL MONITORING SYSTEM FOR MONITORING AN SUBSEA, SUB-SURFACE WELL

(71) Applicant: ION Geophysical Corporation, Houston, TX (US)

(72) Inventors: Emerson Verissimo, Houston, TX (US); Darrell Burch, West Columbia, TX (US); Andre Simon Doerfer, Houston, TX (US); Felix Bircher, Houston, TX (US)

(21) Appl. No.: 17/368,146

(22) Filed: Jul. 6, 2021

Related U.S. Application Data
(60) Provisional application No. 63/048,308, filed on Jul. 6, 2020.

(51) Int. Cl. E21B 44/00; E21B 47/001; E21B 49/00; E21B 47/002

(52) U.S. Cl. CPC E21B 44/00; E21B 47/001; E21B 47/14; E21B 47/0025; E21B 49/001

(57) ABSTRACT

Embodiments herein describe apparatus, systems and methods adapted to monitor underwater wells, boreholes, drill holes, etc. (subsea wells). Depending on embodiment, the apparatus, systems and methods can be configured to capture sensor readings and/or to monitor status of a target subsea wells.

### CROSS-REFERENCE TO RELATED APPLICATION

This application claims priority to U.S. Provisional Application No. 63/048,308, filed on Jul. 6, 2020, entitled WELL MONITORING SYSTEM FOR MONITORING AN SUBSEA, SUB-SURFACE WELL, this application is hereby incorporated by reference herein, in the entirety and for all purposes.

### BACKGROUND

This application relates to monitoring of undersea subsurface wells. Applications include, but are not limited to, systems and methods for monitoring undersea wells, drill holes, boreholes and other underwater structures; e.g., for gas and fluid emission.

Natural resources are often found in subsurface geological formations, from which they can be sampled or extracted via boreholes, drill holes and wells. Subsurface formations are also used for resource storage and sequestration, and fluids may be injected into the subsurface during exploration, development or extraction.

Active and inactive wells, drill holes and boreholes are sometimes monitored to detect gas or fluid discharge. Many of these features are located in remote or difficult to access locations, creating an ongoing need for more robust and reliable well and environmental monitoring systems and methods.

### SUMMARY

Systems and methods are disclosed for environmental monitoring. Applications include, but are not limited to, active and inactive underwater, subsurface wells, drill holes, boreholes, etc. (subsea wells). The subsea wells may correspond to a hydrocarbon source located at depth beneath a water column, in some examples. One embodiment herein is a system that includes a well sensor device that includes a funnel configured to be positioned over a subsea well in order to capture a material of interest leaking from the subsea well and a sensor disposed at a top of the funnel and configured to detect the material of interest. The system also includes a well monitoring device configured to be positioned in a water column where the well monitoring device is communicatively coupled to the well sensor device to retrieve sensor readings from the sensor on the well sensor device and a cable configured to connect the well monitor device to a sensor reading port of the well sensor device.

In some embodiments, a well monitoring system or apparatus may be (e.g., communicatively, physically, or both) connected to a Christmas tree. A Christmas tree is an assembly of valves, spools and fittings connected to a wellhead of a subsea well, and is configured to control flow into or out of the subsea well. A Christmas Tree may provide additional functions including chemical injection points, well intervention means, pressure relief means, monitoring points (such as pressure, temperature, corrosion, erosion, sand detection, flow rate, flow composition, valve and choke position feedback), and connection points for devices such as down hole pressure and temperature transducers (DHPT). Functionality may be extended further by using a control system to monitor, measure, and react to sensor outputs on the Christmas Tree or even down the bore of the subsea well. In some examples, a Christmas tree may include one or more connection ports are used to retrieve one or more sensor readings (e.g., temperature, pressure, flow rate, flow composition, valve positions, Christmas tree position sensors (e.g., pitch, roll, yaw, etc.), etc.).

The well monitoring system may include a well monitoring device configured to connect to at least one of the one or more ports of the Christmas tree to retrieve at least some of the sensor data readings. The well monitoring system may include a well monitoring device that is configured to retrieve and store the sensor readings. The well monitoring device may include a data acquisition system having a memory storage system. The data acquisition system may be configured to retrieve and store the sensor readings. The data acquisition system may be configured to retain a specified number of sensor readings, sensor readings over a specific time period, or all sensor readings until the memory is full. In some examples, the data acquisition system may be configured to store temporal information (e.g., date, time, etc.) for each stored sensor reading. In some examples, the data acquisition system may be configured to store a maximum detected sensor reading for one or more sensors, along with temporal information.

The one or more predetermined events may include detection of at least one of a hydrocarbon resource level, a pressure level, a flow rate, a temperature exceeding an upper threshold and/or falling below a lower threshold, and improper valve configuration, position sensors indicating abnormal position of the Christmas tree (e.g., indicating a collapse or other abnormal movement), loss of communication with the Christmas tree, or any combination thereof. The one or more predetermined events may be detected based on a single sensor reading, a specified number of consecutive sensor readings, a specified number of sensor readings over a specified time period threshold, or any combination thereof. The data acquisition unit and/or the memory storage unit may be configured to detect the one or more predetermined events.

In some examples, the well monitoring device may include one or more detachable (e.g., releasable) emergency beacons that have positive buoyancy properties such that they float to a surface of the water column. The one or more detachable emergency beacons may be attached to the well monitoring device, in some examples. The one or more emergency beacons may be configured to receive RF signals to determine location information (e.g., from a global positioning system, or another location system), transmit messages using RF signals (e.g., the location information, an identifier, alert information associated with a detected event, some or all of the sensor readings), emit an alert or emergency beacon RF signal, etc., or any combination thereof. In some examples, each of the one or more detachable emergency beacons may be configured to transmit messages to a satellite using a satellite communication service (e.g., Iridium messaging service, etc.) in response to a determination that the emergency beacon is at or near the surface of the water. The one or more emergency beacons may be configured to release from the well monitoring device in response to detection of an event of the one or more predetermined events based on the retrieved sensor readings.

In some examples, the well monitoring device may further include one or more detachable (e.g., releasable) surface data carriers that have positive buoyancy properties such that they float to a surface of the water column and are configured to store at least some of the sensor readings such for access once retrieved. The one or more detachable surface data carriers may be attached to the well monitoring device, in some examples. The one or more detachable surface data carriers may be configured to receive RF signals to determine location information (e.g., from a global positioning system, or another location system), transmit messages using RF signals (e.g., the location information, an identifier, some or all of the hydrocarbon readings), emit an alert or emergency beacon RF signal, etc., or any combination thereof. In some examples, each of the one or more detachable surface data carriers may be configured to transmit messages to a satellite using a satellite communication service (e.g., Iridium messaging service, etc.) in response to a determination that the detachable surface data carrier is at or near the surface of the water. The one or more detachable surface data carriers may be configured to release from the well monitoring device periodically (e.g., daily, weekly, monthly, quarterly, semi-annually, annually, etc.) and/or in response to detection of an event of the one or more predetermined events based on the retrieved sensor readings. The periodical intervals may be based on a regulatory requirement, in some examples. The surface data carriers may also be configured to release from the well monitoring device in response to commands sent from an aerial vessel, surface vessel, or underwater vessel. These commands may be transmitted acoustically, optically or via other methods.

The well monitoring device may include sub-surface communication capabilities; e.g., communication through the water (e.g., via an acoustic transponder, optical transmitter, etc.). The well monitoring device can be configured to use the sub-surface communications to communicate with a surface or subsurface vessel. For example, the well monitoring device may use acoustic signals to provide an identifier (e.g., to identify the device or the monitored well or wells), the sensor readings (e.g., including some or all of one or more reading values, a maximum reading value, or any combination thereof), respective temporal information for each respective provided sensor reading, (e.g., respective date, time, etc.), status information (e.g., whether or not an event of the one or more predetermined events have been detected, low battery, memory full, loss of communication, etc.), or any combination thereof to the vessel.

In some examples, the vessel may include a surface, subsurface, manned, autonomous, or any combination thereof type of vessel. In some examples, the well monitoring device may periodically emit the sensor readings. In some examples, the well monitoring device may be configured to provide the sensor readings in response to a request signal received by the well monitoring device from the vessel. That is, the well monitoring device may be configured receive a request signal for the hydrocarbon readings from the vessel.

In some examples, the well monitoring device may further include a communications port configured for a remotely operated vehicle (ROV) interrogation/data download procedure. The communications port may allow transfer of sensor reading data, well as other status data.

In some examples, the well monitoring device may include an internal power source, such as a battery. In some examples, the well monitoring device may be connected to an external power source, such as a sub-surface power generation unit or a surface power generation unit. The sub-surface power generation unit and/or the surface power generation unit may be connected to the well monitoring device via a power cable. In some examples, the power cable may include a data cable to facilitate data communications between the well monitoring device and the sub-surface power generation unit and/or the surface power generation unit, such as to provide the sensor readings and other status information. The surface power generation unit may include a vessel or a buoy. In some examples, the well monitor logger can include a suitable wired communications system, such as electrical, fibre optic, etc., that would allow the well monitoring device to be interconnected with, in one case, other well monitoring devices, sub-surface vessels or buoys or a surface vessel, buoy, platform, or other surface structure (e.g., an oil field production infrastructure).

In some examples, the well monitoring system and/or logger may further include additional sensors to independently monitor environmental data, including seismic sensors, hydrocarbon reading sensors, position sensors, etc. In some examples, the well monitoring system and/or logger may further include one or more cameras configured to take video or periodic snapshots. The data acquisition system may be configured to evaluate the videos or periodic snapshots to detect at least one event of the one or more predetermined events, such as based on detection of bubbles or other visual abnormalities.

### BRIEF DESCRIPTION OF THE DRAWINGS

FIG. 1 is an exploded schematic view of an underwater well monitoring system including a well monitoring device, according to one or more representative examples or embodiments of the disclosure.

FIG. 2 is an isometric or perspective view of an underwater well monitoring device, according to one or more representative examples or embodiments of the disclosure.

FIG. 3 is an isometric or perspective view of an underwater well monitoring device, according to one or more representative examples or embodiments of the disclosure.

FIG. 4 illustrates a well monitoring system that includes a well monitoring device and a well sensor device, according to one or more representative examples or embodiments of the disclosure.

### DETAILED DESCRIPTION

This application describes an apparatus, systems and methods adapted to monitor underwater wells, boreholes, drill holes, etc. (subsea wells). Depending on embodiment, the apparatus, systems and methods can be configured to capture sensor readings and/or to monitor status of a target subsea wells.

Subsurface formations of hydrocarbons (e.g., oil, natural gas, etc.) and other resources have been identified both underground and below the sea floor, for example in bodies of water such as the Gulf of Mexico and the North Sea. In marine applications, exploration and extraction of these resources involves drilling into the sea floor (or seabed), sometimes thousands of meters below the surface of the water, to create wells or boreholes to access the subsurface formations.

When hydrocarbons and other resources are identified in a subsurface formation, a subsea well may be developed to extract the resources. In some examples, fluids may be pumped into the formation during the extraction process. When available resources are exhausted, residual hydrocarbon resources and/or other materials (e.g., fluids and gases) may remain in an abandoned well site, or other active or inactive hydrocarbon source. Sealing and abandonment procedures can be undertaken to prevent residual resources and other fluids or gases from escaping the subsurface formation, and to reduce the chance gases and fluids are released into the surrounding environment via the well or borehole. If the seal is breached or the integrity of the well is compromised, however, hydrocarbons and other gas or fluid components may be emitted into the surrounding water column.

Some regulations may require continuous monitoring of active and inactive subsea wells. Early detection of leakage and other anomalies can reduce the risk and level of environmental exposure, but frequent inspections can be challenging and costly, particularly in remote or difficult-access locations that may be thousands of meters below the surface. The well monitoring system described herein can be used to monitor a subsea well, even in remote, deep-water locations, and can be adapted to detect anomalies based on sensor readings from sensors of the Christmas tree attached to the well. A combination of acoustic (underwater), optical (underwater), and radio-frequency (wireless) communications components can be used to report sensor readings and/or detected events or anomalies, allowing appropriate action to taken to quickly and effectively reduce the risk of environmental exposure.

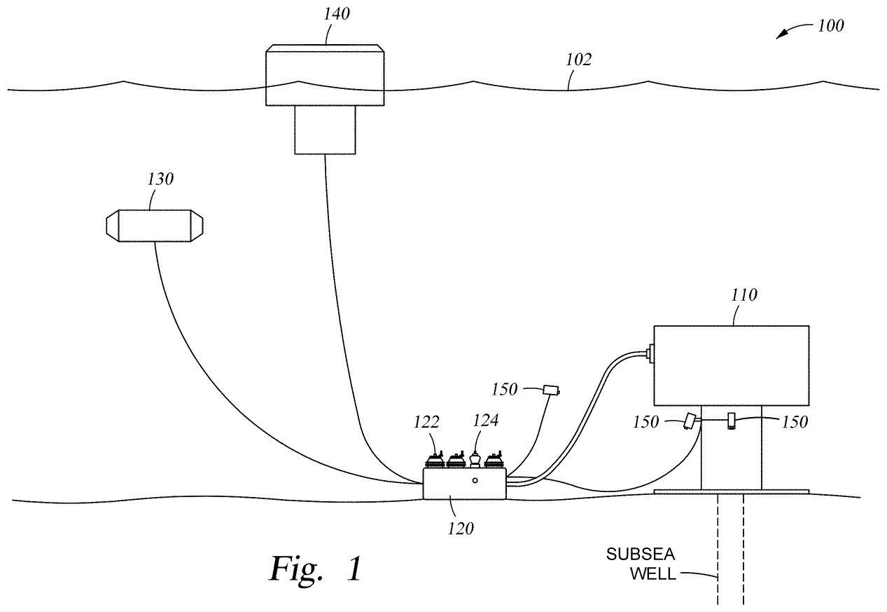

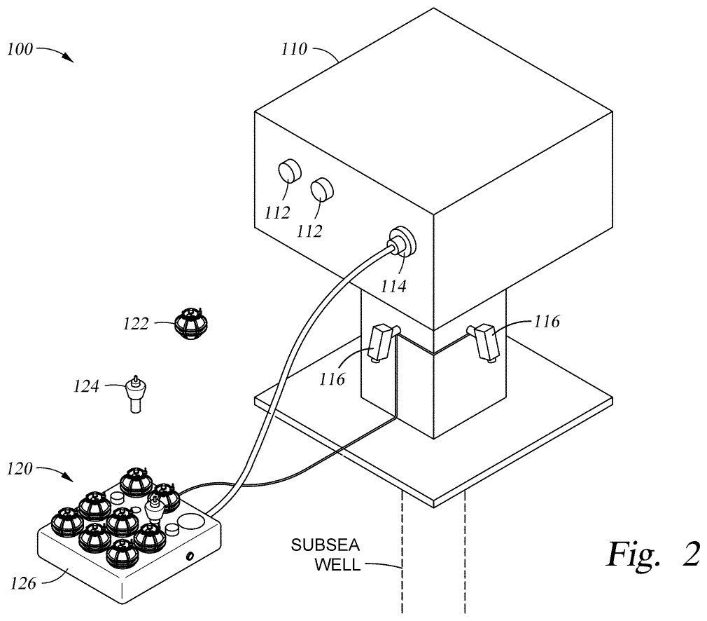

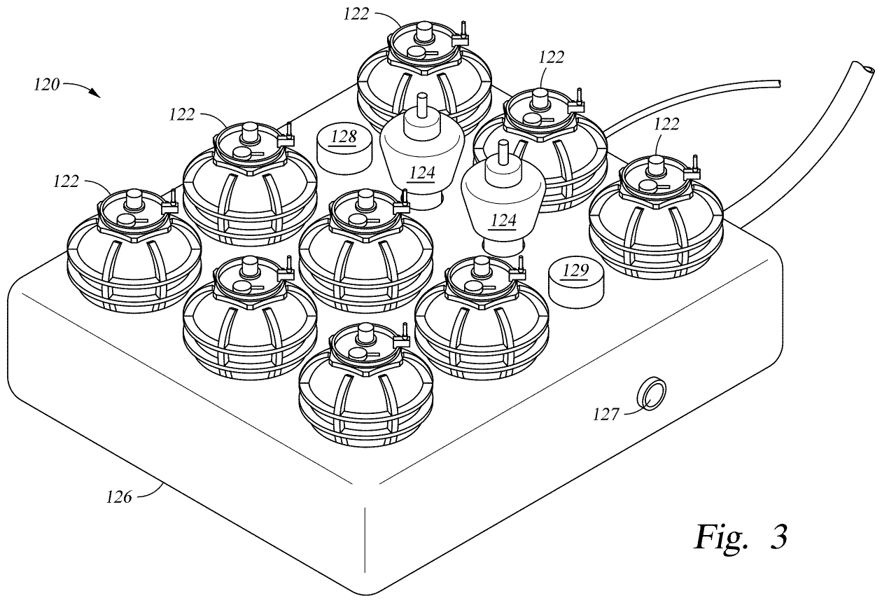

FIG. 1 is an exploded schematic view of an underwater well monitoring system 100 including a well monitoring device 120, according to one or more representative examples or embodiments of the disclosure. FIG. 2 is an isometric or perspective view of the well monitoring device 120, according to one or more representative examples or embodiments of the disclosure. FIG. 3 is an isometric or perspective view of the well monitoring device 120, according to one or more representative examples or embodiments of the disclosure. Common elements among FIGS. 1-3 have been identified using the same reference numbers.

The well monitoring device 120 of the well monitoring system 100 may be connected to a Christmas tree 110 mounted on a wellhead (not shown) of a subsea well (not shown). While the embodiments herein describe a Christmas tree 110, any wellhead interface system or device is contemplated. For example, the embodiments herein can be used with any wellhead interface system that has sensors that monitor a status of a well. The Christmas tree 110 may include an assembly of valves, spools and fittings connected to a wellhead of a subsea well, and is configured to control flow into or out of the subsea well. The Christmas tree 110 may provide additional functions including chemical injection points, well intervention means, pressure relief means, monitoring ports 112 (e.g., pressure, temperature, corrosion, erosion, sand detection, flow rate, flow composition, valve and choke position feedback), and connection ports 114 for devices, such as down hole pressure and temperature transducers (DHPT). Functionality of the Christmas tree 110 may be extended further by using a control system to monitor, measure, and react to sensor outputs on the Christmas Tree 110 or even down the bore of the subsea well. In some examples, the Christmas tree 110 may include one or more connection ports that are used to retrieve one or more sensor readings (e.g., temperature, pressure, flow rate, flow composition, valve positions, Christmas tree 110 position sensors (e.g., pitch, roll, yaw, etc.), etc.).

The well monitoring device 120 may connect to at least one of the monitoring ports 112 and/or the connection ports 114 (sensor reading ports) of the Christmas tree 110 to retrieve at least some of the sensor readings. The well monitoring device 120 may be deployed in a water column below a surface 102 and proximate the Christmas tree 110. In some examples, the well monitoring device 120 may be further physically attached (e.g., via rigidly or via additional tethers) (not shown) to the Christmas tree 110 to hold the well monitoring device 120 in a position proximate the Christmas tree 110.

In addition to receiving sensor data from the Christmas tree 110 in FIG. 1, the well monitoring device 120 is communicatively coupled to a camera 150 (or multiple cameras 150) that captures images of the Christmas tree 110 or the region of the surface around the Christmas tree 110. For example, the camera 150 can capture images of bubbles that indicate a leak from the well, or a shift in the position of the Christmas tree 110 that indicates a potential hazardous situation. For certain depths, ice forming around or on the Christmas tree 110 may indicate a leak of hydrocarbons or other hazardous materials from the well.

The well monitoring device 120 may be configured to retrieve and store the sensor readings and the images captured by the camera 150, as well as to monitor a status of the subsea well based on the sensor readings (e.g., including detecting occurrence of one or more predetermined events). The well monitoring device 120 may be configured to provide an alert in response to detection of one or more predetermined events. The well monitoring device 120 may include a housing 126 configured to retain (e.g., and protect from an undersea environment) a data acquisition system having a memory storage system. The data acquisition system may be configured to retrieve and store the sensor readings and the images of the camera 150, as well as monitor the state of the subsea well. The data acquisition system may be configured to retain a specified number of sensor readings and images, sensor readings or images over a specific time period, or all sensor readings and images until the memory is full. In some examples, the data acquisition system may be configured to store temporal information (e.g., date, time, etc.) for each stored sensor reading or captured image. In some examples, the data acquisition system may be configured to store a maximum detected sensor reading for one or more sensors, along with temporal information. The data acquisition system may include one or more of application-specific integrated circuits (ASICs), field programmable gate arrays (FPGAs), micro-processors, micro-controllers, processor units, any other programmable device or circuitry configured to control operation of the well monitoring device 120, or any combination thereof. In some examples, the data acquisition system may include memory configured to store executable instructions configured to control operation of the well monitoring device 120 when executed by a controller or processor unit. In some examples, the memory may also store an identifier associated with the well monitoring device 120 (and/or a monitored subsea well, the Christmas tree 110, etc., or any combination thereof). The memory may include non-volatile memory, volatile memory, or combinations thereof.

The one or more predetermined events may include detection of at least one of a hydrocarbon resource level, a pressure level, a flow rate, a temperature, etc., exceeding an upper threshold and/or falling below a lower threshold, an improper valve configuration, position sensors indicating abnormal position of the Christmas tree 110 (e.g., indicating a collapse or other abnormal movement), loss of communication with the Christmas tree 110, or any combination thereof. The one or more predetermined events may be detected based on a single sensor reading or image, a specified number of consecutive sensor readings or images, a specified number of sensor readings or images over a specified time period threshold, or any combination thereof. The data acquisition unit and/or the memory storage unit may be configured to detect the one or more predetermined events. For example, to process the captured images, the memory storage unit may include an image processing application for detecting bubbles, ice forming on the Christmas tree, or a change in position of the Christmas tree.

In some examples, the well monitoring device 120 may include one or more detachable (e.g., releasable) emergency beacons 124. The housing of the one or more detachable emergency beacons 124 may be have a design (e.g., materials, shape, density, mass, etc.) that exhibits positive-buoyancy characteristics or properties such that they float to a surface 102 of the water column. The one or more detachable emergency beacons 124 may be attached to an outer surface of the housing 126 of the well monitoring device 120. The data acquisition system may provide an alert by releasing an emergency beacon 124 in response to detection of a release event. The release of an emergency beacon 124 may provide an alert of the release event. A release event may include any of the one or more predetermined events previously described. The well monitoring device 120 may include a respective release mechanism (e.g., mechanical mechanisms, magnetic mechanisms, or any combination thereof) (not shown) for each of the one or more detachable emergency beacons 124 that is actuated by the data acquisition unit to release a respective emergency beacon 124 in response to detection of the release event, in some examples.

The one or more emergency beacons 124 may be configured to receive RF signals to determine location information (e.g., from a global positioning system, or another location system), transmit messages using RF signals (e.g., the location information, an identifier, alert information associated with a detected event, some or all of the sensor readings), emit an alert or emergency beacon RF signal, etc., or any combination thereof. In some examples, each of the one or more detachable emergency beacons 124 may be configured to transmit messages to a satellite using a satellite communication service (e.g., Iridium messaging service, etc.) in response to a determination that the emergency beacon is at or near the surface of the water.

In some examples, the well monitoring device 120 may further include one or more detachable (e.g., releasable) surface data carriers 122 that are configured to store at least some of the sensor readings and some of the video data for access once retrieved. The housing of the one or more surface data carriers 122 may be have a design (e.g., materials, shape, density, mass, etc.) that exhibits positive-buoyancy characteristics or properties such that they float to a surface 102 of the water column. The one or more detachable surface data carriers 122 may be attached to an outer surface of the housing 126 of the well monitoring device 120. The data acquisition system may provide an alert by releasing a surface data carrier 122 in response to detection of a release event. A release event may include any of the one or more predetermined events previously described. The release events for the one or more detachable surface data carriers 122 may be at least partially different than the release events of the one or more detachable emergency beacons 124, in some examples.

The data acquisition system may also additionally or alternatively release individual ones of the one or more surface data carriers 122 periodically (e.g., after a predetermined number of readings are captured or after a predetermined number of minutes, hours, days, weeks, months, years, etc., have elapsed, or any combination thereof). In another embodiment, the data acquisition system releases one or more surface data carriers 122 in response to a command received from a surface vessel. For example, the vessel may use acoustic data signals or an optical data signal to transmit an instruction to an acoustic or optical receiver on the well monitoring device 120 to release a surface data carrier 122. The well monitoring device 120 may include a respective release mechanism (e.g., mechanical mechanisms, magnetic mechanisms, or any combination thereof) (not shown) for each of the one or more detachable surface data carriers 122 that is actuated by the data acquisition unit to release a respective surface data carrier 122 in response to detection of the release event, in some examples.

The one or more detachable surface data carriers 122 may be configured to receive RF signals to determine location information (e.g., from a global positioning system, or another location system), transmit messages using RF signals (e.g., the location information, an identifier, some or all of the hydrocarbon readings), emit an alert or emergency beacon RF signal, etc., or any combination thereof. In some examples, each of the one or more detachable surface data carriers 122 may be configured to transmit messages to a satellite using a satellite communication service (e.g., Iridium messaging service, etc.) in response to a determination that the detachable surface data carrier is at or near the surface of the water. The one or more detachable surface data carriers may be configured to release from the well monitoring device 120 periodically (e.g., daily, weekly, monthly, quarterly, semi-annually, annually, etc.) and/or in response to detection of an event of the one or more predetermined events based on the retrieved sensor readings. The periodical intervals may be based on a regulatory requirement, in some examples.

The well monitoring device 120 may include sub-surface communication capabilities; e.g., communication through the water (e.g., via an acoustic transponder 128 or an optical transmitter). The well monitoring device 120 can be configured to use the sub-surface communications to communicate with a surface or subsurface vessel. For example, the acoustic transponder 128 (or an optical transmitter) may transmit acoustic signals to provide an identifier (e.g., to identify the device or the monitored well or wells), the sensor readings (e.g., including some or all of one or more reading values, one or more maximum or minimum sensor reading values, or any combination thereof), respective temporal information for each respective provided sensor reading, (e.g., respective date, time, etc.), status information (e.g., whether or not an event of the one or more predetermined events have been detected, low battery, memory full, loss of communication, etc.), or any combination thereof to the vessel. In some embodiments, the sub-surface communication capabilities (e.g., acoustic or optical data signals) of the well monitoring device 120 may be sufficient to transmit information regarding the sensor readings or images captured by the cameras to a subsurface or surface vessel, in which case the releasable data carriers 122 may be omitted.

In some examples, the vessel may include a surface, subsurface, manned, autonomous, or any combination thereof type of vessel. In some examples, the well monitoring device 120 may periodically emit the sensor readings. In some examples, the well monitoring device 120 may be configured to provide the sensor readings in response to a request signal received by the well monitoring device 120 from the vessel. That is, the well monitoring device 120 may be configured receive a request signal for the hydrocarbon readings from the vessel.

In some examples, the well monitoring device 120 may further include a communications port 127 configured for a remotely operated vehicle (ROV) interrogation/data download procedure. The communications port 127 may allow transfer of sensor reading data, well as other status data.

In one embodiment, camera 150 is mounted on a ROV (which could be controlled by an umbilical cord connected to a surface vessel) or an autonomous underwater vehicle (AUV) rather than being mounted on the sea floor as shown in FIG. 1. In this embodiment, the camera on the ROV or AUV captures images while the well monitoring device 120 captures the sensor data from the Christmas tree. The sensor data and images can then be evaluated separately or in combination using a computing system on the vessel or a cloud computing environment to determine a status of the well.

The well monitoring device 120 includes an internal power source (not shown), such as a battery. In some examples, the well monitoring device 120 may optionally be connected to an external power source, such as a sub-surface power generation unit 130 or a surface power generation unit 140. The sub-surface power generation unit 130 and/or the surface power generation unit 140 may be connected to the well monitoring device 120 via a power cable. The sub-surface power generation unit 130 may include a buoy. The surface power generation unit 140 may include a vessel, a buoy, a platform, or other surface structure (e.g., an oil field production infrastructure). In some examples, the well monitor device 120 can include a suitable wired communications system 129, such as electrical, fibre optic, etc., that would allow the well monitoring device 120 to be interconnected with, in one case, other well monitoring devices, sub-surface vessels or buoys (e.g., including the sub-surface power generation unit 140) or a surface vessel, buoy, platform, or other surface structure (e.g., an oil field production infrastructure) (e.g., including the surface power generation unit 140). In some examples, the power cable may include a communications cable to facilitate data communications between the well monitoring device 120 and the sub-surface power generation unit 130 and/or the surface power generation unit 140.

In some examples, the well monitoring system 100 and/or device 120 may further include additional sensors to independently monitor environmental data, including seismic sensors, hydrocarbon reading sensors, position sensors, accelerometers, etc. In some examples, the well monitoring system 100 and/or device 120 may further include one or more cameras 116 (which may be the same as the cameras 150 in FIG. 1) configured to take video or periodic snapshots. The additional sensors and/or cameras may be used to detect one of more of the predetermined events. For example, the data acquisition system may be configured to evaluate the videos or periodic snapshots to detect at least one event of the one or more predetermined events, such as based on detection of bubbles or other visual abnormalities.

In some examples, the one or more predetermined events may further include damage to or excessive forces applied to the well monitoring device 120 by an external stimulus, such as being damaged by a vessel (e.g., or other physical object, such as a net), marine life, a seismic event, a catastrophic event associated with the subsea well, etc.

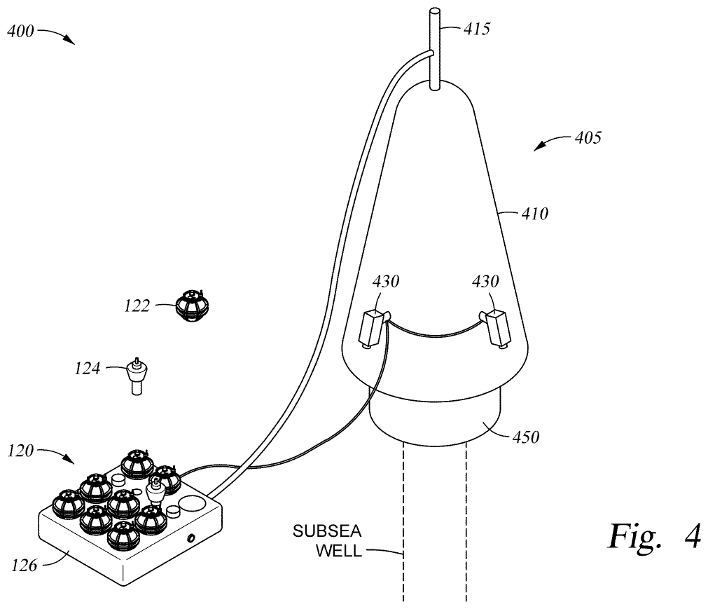

FIG. 4 illustrates a well monitoring system 400 where a well sensor device 405 is mounted on a well cap 450. In one embodiment, the well sensor device 405 may be used to monitor wells (e.g., inactive wells) that have been capped with devices (e.g., the well cap 450) that do not have integrated sensors, unlike the Christmas tree discussed above. As shown, the well sensor device 405 includes a funnel 410 that fits over the well cap 450. For example, the funnel 410 may be arranged over the well cap 450 such that a portion of the well cap 450 is contained within an interior defined by the funnel 410. Further, while FIG. 4 illustrate some space between the bottom of the funnel 410 and the subsurface, in one embodiment, the bottom of the funnel 410 may rest on the subsurface such that all of the well cap 450 above the subsurface is contained within the interior of the funnel 410. In any case, the bottom diameter of the funnel 410 may be such that the funnel 410 covers most if not all of the well cap 450 as well as a region of the subsurface around the well cap 450. That way, any leaking hydrocarbons or other material of interest rising from the well cap 450 (or the region around the well cap 450) is captured by the funnel 410. That is, any gases released from the well cap 450 or the subsurface around the well cap 450 rise and are captured within the funnel 410.

A sensor 415 is disposed at a top of the funnel 410 for detecting hazardous materials that may leak from the well. That is, as the hazardous materials rise, the funnel 410 directs the material to the top of the funnel 410 where the sensor 415 is arranged. In one embodiment, the hazardous materials (e.g., the material of interest) pass through or over the sensor 415 in order to exit the top of the funnel 410. For example, the sensor 415 may include an aperture so that hazardous material captured by the funnel 410 must first pass through the sensor 415 before it exits the funnel 410. In one embodiment, the sensor 415 is a hydrocarbon sensor for detecting hydrocarbon materials that may leak from the well, but in general the sensor 415 can be any type of sensor for detecting materials of interest that may leak from a well.

While the funnel 410 in FIG. 4 includes a single sensor, there may be other sensors disposed at other locations on an inner surface of the funnel 410. In addition to the sensor 415, the well sensor device 405 includes one or more cameras 430 which capture images of the interior funnel 410, the well cap 450, or the area of the subsurface surrounding the well cap 450. For example, one camera 150 may capture images of the subsurface while another camera 150 is disposed at the top of the funnel 405 and looks down vertically towards the well cap 450. While the well sensor device 405 in FIG. 4 includes both the sensor 415 and the cameras 430, in other embodiments, the well sensor device 405 may have only the sensor 415, or only the cameras 430 rather than both.

The sensor 415 and cameras 430 are communicatively coupled to the well monitoring device 120 which was discussed above in FIGS. 1-3. For example, one or more cables may connect one or more ports of the well monitoring device 120 to one or more ports of the well sensor device 405. The well monitoring device 120 in FIG. 4 can have any of the devices, components, and functions as discussed above in FIGS. 1-3. Further, the sensor data and the captured images can be transmitted to the surface using any of the techniques above to be analyzed in order to determine a status of the well. Thus, FIG. 4 illustrates a system 400 where the well monitoring device 120 and the well sensor device 405 can be used to monitor a well that did not previously have a sensing device to monitor its status. For example, the well monitoring device 120 and the well sensor device 405 can be installed as a complete system to monitor the well and provide alerts if a hazardous material is detected.

While the funnel 410 in FIG. 4 has a frustoconical shape, this is just one suitable example. The funnel 410 may also have a frustopyramidal shape. In general, the funnel 410 (or canopy) can have any shape that guides buoyant materials leaking from the well cap or the subsurface to a sensor.

Further, while the cameras 150 are illustrated in FIG. 4 as being integrated with the funnel 410, in other embodiments the cameras 150 may be mounted on the subsurface using separate mounts, or a ROV or AUV may include cameras for monitoring the well cap 450 and the region surrounding the well cap 450.

### Examples

Example 1 is a system comprising: a subsea well monitoring device configured to be positioned below in a water column below a surface, wherein the subsea well monitoring device is connected to a Christmas tree associated with a subsea well, wherein the well monitor device is configured to retrieve sensor readings via a sensor reading port of the Christmas tree and to detect a release event based on the sensor readings, wherein the well monitor device is further configured to provide an alert in response to detection of a release event; and a cable configured to connect the well monitor device to the sensor reading port of the Christmas tree.

In Example 2, the subject matter of Example 1 includes, wherein the subsea well monitoring device includes an emergency beacon having a positive buoyancy property, wherein the well monitor device is configured to provide the alert by releasing the emergency beacon from the well monitor device.

In Example 3, the subject matter of Example 2 includes, wherein the emergency beacon is configured to emit an emergency beacon radio frequency signal.

In Example 4, the subject matter of Example 3 includes, wherein the emergency beacon radio frequency signal includes an indication of the release event, one or more of the sensor readings, an identifier associated with the subsea well monitor device, a location of the emergency beacon, or a combination thereof.

In Example 5, the subject matter of Examples 1˜4 includes, wherein the subsea well monitoring device is further configured to detect a second release event based on the sensor readings and to release a surface data carrier having a positive buoyancy property in response to the second release event.

In Example 6, the subject matter of Example 5 includes, wherein the surface data carrier is configured to emit an radio frequency signal that includes an indication of the second release event, one or more of the sensor readings, an identifier associated with the subsea well monitor device, a location of the surface data carrier, or a combination thereof.

In Example 7, the subject matter of Example 6 includes, wherein the second release event includes detection of at least one of a hydrocarbon resource level, a pressure level, a flow rate, or a temperature exceeding crossing a threshold value, an improper valve configuration of the Christmas tree, position sensors indicating abnormal position of the Christmas tree, or a loss of communication with the Christmas tree.

In Example 8, the subject matter of Examples 6-7 includes, wherein the second release event includes detection of at least one of recording a predetermined number of readings or a predetermined period of time has elapsed since a previous release event.

In Example 9, the subject matter of Examples 1-8 includes, wherein the release event includes detection of at least one of a hydrocarbon resource level, a pressure level, a flow rate, or a temperature exceeding crossing a threshold value, an improper valve configuration of the Christmas tree, position sensors indicating abnormal position of the Christmas tree, or a loss of communication with the Christmas tree.

In Example 10, the subject matter of Examples 1-9 includes, wherein the subsea well monitoring device includes an acoustic transducer configured to provide the alert by transmitting an acoustic signal.

In Example 11, the subject matter of Example 10 includes, wherein the acoustic signal includes an indication of the release event, one or more of the sensor readings, an identifier associated with the subsea well monitoring device, or a combination thereof.

In Example 12, the subject matter of Examples 10-11 includes, wherein the subsea well monitoring device is further configured to cause the acoustic transducer to transmit a sensor reading of the sensor readings through the water column to a surface or subsurface vessel in response to receipt of a request for the sensor reading from the surface or subsurface vessel.

In Example 13, the subject matter of Examples 1-12 includes, wherein the subsea well monitoring device includes memory configured to store the sensor readings.

In Example 14, the subject matter of Examples 1-13 includes, wherein the subsea well monitoring device further includes a power source configured to provide power to operate the subsea well monitoring device.

In Example 15, the subject matter of Examples 1-14 includes, a sub-surface power generation unit or a surface power generation unit configured to provide power to the subsea well monitoring device.

In Example 16, the subject matter of Examples 1-15 includes, wherein the subsea well monitoring device further includes a communications port configured to couple to a subsea vessel to provide the sensor readings.

In Example 17, the subject matter of Examples 1-16 includes, a camera coupled to the subsea well monitoring device, wherein the sensor readings include images captured via the camera.

In Example 18, the subject matter of Examples 1-17 includes, wherein the subsea well monitoring device further includes a wired communication system configured to provide the sensor data, the alert, or a combination thereof to a sub-surface or a surface vessel.

In Example 19, the subject matter of Example 18 includes, wherein subsea well monitoring device includes an optical transmitter to communicate over fiber optic cables of the wired communication system.

Example 20 is a non-transitory, computer-readable medium having program code stored thereon, the program code executable on a computer processor to perform a method or operate a system or apparatus according to any of the above Examples.

Example 21 is a method to implement of any of Examples 1-20.

Any system described or depicted herein, any apparatus described or depicted herein, any method or process described or depicted herein, or a non-transitory, computer-readable medium having program code stored thereon, the program code executable on a computer processor to perform a method or operate a system or apparatus according to any of the above examples.

From the foregoing it will be appreciated that, although specific embodiments of the disclosure have been described herein for purposes of illustration, various modifications may be made without deviating from the spirit and scope of the disclosure. Accordingly, the disclosure is not limited except as specified by the claims. Changes can be made and equivalents may be substituted to adapt these teachings to other problems and applications, while remaining within invention as claimed.

1. A system comprising:
a well sensor device comprising:
a funnel configured to be positioned over a subsea well in order to capture a material of interest leaking from the subsea well, and
a sensor disposed at a top of the funnel and configured to detect the material of interest; and
a well monitoring device configured to be positioned in a water column, wherein the well monitoring device is communicatively coupled to the well sensor device to retrieve sensor readings from the sensor on the well sensor device, and
a cable configured to connect the well monitor device to a sensor reading port of the well sensor device.

2. The system of claim 1, further comprising:
a camera mounted onto the funnel, wherein the camera is configured to capture images of an interior of the funnel, wherein the camera is communicatively coupled to the well monitoring device.

3. The system of claim 1, wherein the funnel comprises a diameter large enough so that the funnel can be disposed over a well cap.

4. The system of claim 1, wherein the funnel comprises one of a frustoconical or frustopyramidal shape.

5. The system of claim 1, wherein the well monitoring device includes an emergency beacon having a positive buoyancy property, wherein the well monitor device is configured to provide an alert based on the sensor readings by releasing the emergency beacon from the well monitor device.

6. The system of claim 5, wherein the emergency beacon is configured to emit an emergency beacon radio frequency signal.

7. The system of claim 6, wherein the emergency beacon radio frequency signal includes an indication of the alert, one or more of the sensor readings, an identifier associated with the well monitor device, a location of the emergency beacon, or a combination thereof.

8. The system of claim 1, wherein the well monitoring device is further configured to detect a release event based on the sensor readings and to release a surface data carrier having a positive buoyancy property in response to the release event.

9. The system of claim 8, wherein the surface data carrier is configured to emit an radio frequency signal that includes an indication of the release event, one or more of the sensor readings, an identifier associated with the well monitor device, a location of the surface data carrier, or a combination thereof.

10. The system of claim 9, wherein the release event includes detection of at least one of a hydrocarbon resource level, a pressure level, a flow rate, or a temperature exceeding crossing a threshold value, position sensors indicating abnormal position of the funnel, or a loss of communication with the funnel.

11. The system of claim 8, wherein the release event includes detection of at least one of recording a predetermined number of readings or a predetermined period of time has elapsed since a previous release event.

13. The system of claim 1, wherein the well monitoring device includes an acoustic transducer configured to provide an alert based on the sensor readings by transmitting an acoustic signal.

14. The system of claim 13, wherein the acoustic signal includes an indication of the release event, one or more of the sensor readings, an identifier associated with the well monitoring device, or a combination thereof.

15. The system of claim 13, wherein the well monitoring device is further configured to cause the acoustic transducer to transmit the sensor readings through the water column to a surface or subsurface vessel in response to receipt of a request for the sensor readings from the surface or subsurface vessel.

16. The system of claim 1, wherein the well monitoring device includes memory configured to store the sensor readings.

17. The system of claim 1, wherein the well monitoring device further includes a power source configured to provide power to operate the well monitoring device.

18. The system of claim 1, further comprising a sub-surface power generation unit or a surface power generation unit configured to provide power to the well monitoring device.

19. The system of claim 1, wherein the well monitoring device further includes a communications port configured to couple to a subsea vessel to provide the sensor readings.

20. The system of claim 1, wherein the well monitoring device further includes a wired communication system configured to provide the sensor readings, an alert based on the sensor readings, or a combination thereof to a sub-surface or a surface vessel.

21. The system of claim 20, wherein the well monitoring device includes an optical transmitter to communicate over fiber optic cables of the wired communication system.

22. The system of claim 1, wherein the well monitoring device includes an optical or acoustic transmitter to communicate the sensor readings to a vessel.

23. The system of claim 1, further comprising a camera configured to capture image data of the subsea well, wherein the camera is communicatively coupled to the well monitoring device.

24. The system of claim 23, wherein the well monitoring device is further configured to release a surface data carrier having a positive buoyancy property in response to receiving an acoustic or optical signal from a vessel, wherein the surface data carrier can store the sensor readings and the image data of the subsea well.

25. The system of claim 1, further comprising an underwater vehicle comprising a camera configured to capture video data of the subsea well.

26. The system of claim 1, wherein the well monitoring device is further configured to release a surface data carrier in response to a signal received from an aerial, surface or underwater vessel at a receiver on the well monitoring device.

27. The system of claim 26, wherein the signal is at least one of an acoustic or optical signal transmitted by the aerial, surface or underwater vessel.

28. A system comprising:
a subsea well monitoring device configured to be positioned in a water column, wherein the subsea well monitoring device is connected to a Christmas tree associated with a subsea well, wherein the well monitor device is configured to retrieve sensor readings via a sensor reading port of the Christmas tree and to detect a release event based on the sensor readings, wherein the subsea well monitor device is further configured to provide an alert in response to detection of a release event; and
a cable configured to connect the subsea well monitor device to the sensor reading port of the Christmas tree.
